(19) United States
(12) Patent Application Publication
(10) Pub. No.: US 2007/0223168 A1
(43) Pub. Date: Sep. 27, 2007

(54) Method for locally suppressing a disturbance of a reference line

(75) Inventors: Daniele Vimercati, Besana in Brianza (IT); Efrem Bolandrina, Alzano Lombardo (IT); Pierguido Garofalo, San Donato Milanese (IT)

Correspondence Address: JENKENS & GILCHRIST, PC, 1445 ROSS AVENUE, SUITE 3200, DALLAS, TX, 75202, US

(73) Assignee: STMicroelectronics S.r.l., Agrate Brianza (IT)

(21) Appl. No.: 11/712,239

(22) Filed: Feb. 27, 2007

(30) Foreign Application Priority Data
Feb. 28, 2006 (EP) 06425124.2

(51) Int. Cl. H02H 9/06

(52) U.S. Cl. 361/118

(57) ABSTRACT

Local suppression of a disturbance of a reference line is accomplished by supplying, on an internal node, a Band Gap voltage signal that is stable in temperature and power supply; driving a controlled current generator generating a controlled current signal by means of the Band Gap voltage signal; locally suppressing a disturbance of the reference line by means of a disturbance suppression circuit connected to the internal node acting on the Band Gap voltage signal; and mirroring a current signal generated on the reference line which is an output terminal of the Band Gap circuitry.

### PRIORITY CLAIM

The present application claims priority from European Patent Application No. 06425124.2 filed Feb. 28, 2006, the disclosure of which is hereby incorporated by reference.

### BACKGROUND OF THE INVENTION

1. Technical Field of the Invention

The present invention relates to a method for locally suppressing a disturbance of a reference line.

The invention particularly, but not exclusively, relates to the generation of a controlled current signal for banks of sense amplifiers in memory devices of the Dual Work type and the following description is made with reference to this field of application in order to simplify its disclosure.

2. Description of Related Art

As it is well known, memory devices of the Flash EPROM type, so called Dual Work, have the possibility of simultaneously and independently reading on two different memory partitions, a first partition under a real reading condition and a second partition under a verify after modification condition.

Thus, these devices need a sense amplifier structure with high parallelism for having a high flow of output data. In particular, these sense amplifiers are organized in banks.

It is also known that each sense amplifier uses, for its operation, a reference voltage that is stable in power supply and temperature, usually called a Band Gap voltage and hereafter indicated as a BGAP voltage. This BGAP voltage is usually generated by a so called Band Gap Reference Voltage Generator, normally located inside the memory device.

During the operation of the memory device, the switching on of a bank of sense amplifiers produces a transient disturbance on the Band Gap voltage BGAP, which in turn affects the performance of another bank of sense amplifiers that maybe already be in an on state. In general, this cross disturbance phenomenon is real also in the case of single sense amplifiers.

More in detail, inside a sense amplifier the Band Gap voltage BGAP is generally used for generating a controlled current, i.e. a current showing a desired progress in temperature and power supply.

To this purpose, it is known to use a transient of the MOS type with N channel, in particular of the Low Voltage type (indicated as a LV transistor) degenerated in correspondence with its source terminal by a degeneration resistor. This LV transistor has a gate terminal controlled by the Band Gap voltage BGAP.

The degeneration resistor and the LV transistor are selected so as to obtain a controlled progress of the current thus generated with respect to variations of current and power supply, this progress being established, for example, on the basis of the needs of the memory device design.

The so obtained controlled current is then drawn from a current mirror, usually realized with MOS transistors with P channel and used in the sense amplifier, in any circuit node inside it where a controlled current signal is requested.

To avoid that the sense amplifier consumes also when it is not used, due to this controlled current generator, this current mirror is also equipped with enable switches, also these latter being usually realized by means of P channel MOS transistors.

An embodiment of the sense amplifier architecture described, i.e. of the generation circuitry, starting from a Band Gap voltage stable in temperature and power supply, of the controlled current is schematically shown in FIG. 1, globally indicated with 1 and hereafter called Band Gap circuitry.

In particular, the Band Gap circuitry 1 essentially comprises a controlled current generator 2, a current mirror 3 and an enable circuitry 4, inserted, in cascade to each other, between a first and a second voltage reference, in particular a supply Vdd and a ground GND.

As above described, the controlled current generator 2 comprises an LV transistor M1, in particular of the MOS type with N channel, having a control terminal or gate connected to an input terminal IN of the Band Gap circuitry 1, receiving the Band Gap voltage BGAP, a first conduction terminal, in particular a source terminal, connected to the ground GND through a degeneration resistor R0 and a second conduction terminal, in particular a drain terminal, connected to the current mirror 3.

In turn, the current mirror 3 comprises a first mirror transistor M2, in particular of the MOS type with P channel, being diode configured, inserted between the enable circuitry 4 and the controlled current generator 2 and having a control terminal or gate connected to a control terminal or gate of a second mirror transistor M3, inserted between the enable circuitry 4 and an output terminal OUT of the Band Gap circuitry 1. On the output terminal OUT of the Band Gap circuitry 1 an output controlled current signal I_OUT is then generated.

Finally, the enable circuitry 4 comprises a first enable transistor M4 inserted between the supply reference Vdd and the first mirror transistor M2 of the current mirror 3 and having a control terminal or gate receiving an enable signal SAEN_N, as well as a second enable transistor M5 inserted between the supply reference Vdd and the second mirror transistor M3 of the current mirror 3 and having a control terminal or gate receiving the enable signal SAEN_N.

In the embodiment shown in FIG. 1, the LV transistor M1 of the controlled current generator 2 has a bulk terminal connected to the ground GND, while the mirror transistors M2 and M3 as well as the enable transistors M4 and M5 have bulk terminals connected to the supply voltage reference Vdd.

When the sense amplifier comprising the Band Gap circuitry 1 is switched on, the enable signal SAEN_N passes from a value corresponding to the supply reference Vdd to a ground value GND.

In an initial step, the drain terminal of the LV transistor M1 of the controlled current generator 2 is disconnected from the rest of the circuitry of the sense amplifier and the LV transistor M1 is on. Thus, the channel of this LV transistor M1 is formed and, through the degeneration resistor R0, it is at a ground potential value GND, usually 0V.

Under these conditions, also the drain terminal of the LV transistor M1 is thus at a ground potential value GND, i.e. at 0V potential.

At the switching on of the sense amplifier, the potential values of the source terminals of the transistors M2 and M3 of the current mirror 3 are brought to the value of the supply voltage reference Vdd and—in consequence—a current starts to flow in these transistors and the potential of the drain terminal of the LV transistor M1 enhances up to a value equal to a tripping voltage which enables the current mirror 3 to operate correctly.

With the enhancement of the potential of this drain terminal of the LV transistor M1 the channel is no longer uniformly biased at the ground potential value GND.

Thus, due to its capacitive coupling to the channel and to the drain terminal, also the gate terminal of the LV transistor M1 tends to “move upwards”, i.e. it tends to reach greater potential values thus creating a disturbance in the Band Gap voltage value which is transferred onto the generated current value.

All this occurs in real situations, since the Band Gap voltage BGAP is not produced, obviously, by an ideal voltage generator and thus only after a certain period of time, indicated as the disturbance period, this capacitive coupling disturbance between terminals of the LV transistor M1 is recovered by the generator—real—of the Band Gap voltage BGAP.

This mechanism of generation and recovery of the capacitive coupling disturbance is schematically shown in FIG. 2. In particular, in FIG. 2 the diagrams A and B show a first and a second enable signal, SA_EN Bank(1) and SA_EN Bank(2), which switching on and off (in correspondence with different time instants and for a high and low value of the enable signal, respectively) a first and a second bank of sense amplifiers, for example of a memory device of the Dual Work type.

The switching on of the banks of sense amplifiers changes the progress of the Band Gap voltage signal BGAP, as shown in the diagram C, in particular enhancing it in correspondence with the switching on of a bank of sense amplifiers and decreasing it in correspondence with its switching off, with overlapping of these enhancements and decreases in the case of different banks of sense amplifiers. As above explained, the diagram C shows how the Band Gap voltage BGAP departs from its ideal value BGAP Typical Value for the disturbance period, indicated with Tr in FIG. 2.

During the disturbance period Tr also the controlled current reference values a bank of sense amplifiers is supplied with, indicated as I_ref Bank(1) and I_ref Bank(2) thus show a progress affected by the switching on and by the switching off of another bank, as the diagrams D and E of FIG. 2 show.

In other words, the switching on/off of a bank of sense amplifiers affects the other banks of sense amplifiers in the memory device.

It is worthwhile to note that, since the circuit node wherein the Band Gap voltage BGAP is present is shared (indicated as BGAP node) by all the sense amplifiers of a partition (and of all the partitions) of the memory device connected to these sense amplifiers and since the number of sense amplifiers per partition is very high (normally higher than 100) it is impossible to stabilize this BGAP node by simply “reinforcing” the Band Gap voltage generator BGAP, for example with an over-dimensioning of its output buffer.

It is also possible to locally interface the Band Gap voltage value BGAP for each partition of the memory device by means of a suitable analog buffer. In reality, such a solution is expensive in terms of area and/or of consumption.

Finally, it is possible to introduce a local filtering of the Band Gap voltage value BGAP by means of suitable resistors connected between each partition and the BGAP node, which is a strongly “capacitive” node. In this case, each resistor realizes, with such a BGAP node, a low-pass filter.

In reality, by using such a local filtering, the value of the controlled current the sense amplifiers are supplied with is, however, locally disturbed inside the bank being switched on, the switching on occurrence however producing a much more modest effect on a possible further bank being already active. Moreover, the action of such a local filtering is slow.

In substance, we can say that memory devices realized up to now show the common problem of the mutual influence between the banks of sense amplifiers they contain, the switching on of a bank of sense amplifiers however introducing a disturbance for another bank already on, with consequent potential reading errors.

There is accordingly a need in the art to devise a method for generating a controlled current and a relative Band Gap circuitry, for example inside a sense amplifier, having such structural and functional characteristics as to allow to eliminate or in any case reduce the disturbances linked to the switching on and to the switching off of these circuitries, thus overcoming the limits and the drawbacks still affecting the devices realized according to the prior art.

### SUMMARY OF THE INVENTION

The solution idea underlying the present invention is that of locally suppressing, by means of a suitable suppression circuit, the disturbances affecting the controlled current generated starting from a Band Gap voltage and linked to the capacitive couplings inside the Band Gap circuitry.

In an embodiment, a method for locally suppressing a disturbance of a reference line comprises supplying, on an internal node, a Band Gap voltage signal that is stable in temperature and power supply, driving a controlled current generator generating a controlled current signal by means of the Band Gap voltage signal, locally suppressing a disturbance of the reference line by means of a disturbance suppression circuit connected to the internal node acting on the Band Gap voltage signal, and mirroring a current signal generated on the reference line which is an output terminal of the Band Gap circuitry.

In another embodiment, a method for generating a controlled current by means of a Band Gap circuitry comprises supplying, on a Band Gap node, a Band Gap voltage signal that is stable in temperature and power supply, driving a controlled current generator by means of the Band Gap voltage signal, locally suppressing a disturbance of a controlled current signal generated by the controlled current generator by means of a disturbance suppression circuit connected to the Band Gap node acting on the Band Gap voltage signal, and mirroring the controlled current signal generated on an output terminal of the Band Gap circuitry.

In yet another embodiment, a circuit for suppressing disturbances of a reference line where a controlled current signal is generated by a Band Gap circuitry on a Band Gap node comprises at least one compensation capacitor inserted between the Band Gap node and an inner circuit node of the disturbance suppression circuit, in turn connected to a first voltage reference by means of an input transistor having a control terminal connected to an input terminal of the disturbance suppression circuit and receiving an enable signal.

In another embodiment, a Band Gap circuitry, inserted between a first and a second voltage reference, comprises a controlled current generator, being connected to an input terminal receiving a Band Gap voltage signal that is stable in temperature and power supply, a current mirror, being connected to an output terminal suitable for supplying a controlled current signal, an enable circuitry, receiving an enable signal, and a circuit for suppressing disturbances connected to the input terminal of the Band Gap circuitry.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIG. 1 schematically shows a Band Gap circuitry, inside a sense amplifier and realized according to the prior art;

FIG. 2 schematically shows the progress of signals inside a first and a second bank of sense amplifiers equipped with the Band Gap circuitry of FIG. 1;

FIG. 3 schematically shows a Band Gap circuitry realized according to an embodiment of the invention;

FIGS. 4A and 4B schematically show a circuit for suppressing disturbances inside the circuitry of FIG. 3.

### DETAILED DESCRIPTION OF THE DRAWINGS

The present invention arises from the consideration that, in its most general form, a disturbance linked to the switching on of a sense amplifier must be locally suppressed, so as to avoid influencing the operation of a further sense amplifier already operating, for example in a memory device of the Dual Work type, where these sense amplifiers are grouped in banks and can operate simultaneously.

Advantageously according to an embodiment of the invention, a method is proposed for locally suppressing a disturbance of a reference line comprising:
supplying, on an internal node, a Band Gap voltage signal that is stable in temperature and power supply;
driving a controlled current generator generating a controlled current signal by means of the Band Gap voltage signal;
locally suppressing a disturbance of the reference line by means of a disturbance suppression circuit connected to the internal node acting on the Band Gap voltage signal; and
mirroring a current signal generated on the reference line which is an output terminal of the Band Gap circuitry.

Locally suppressing the disturbance of the controlled current signal comprises emulating a behavior that is opposite to a behavior of a load circuit connected to the Band Gap circuitry.

Moreover, the emulating operation provides for the use of a compensation capacitor connected to the Band Gap node and driven by an enable signal opposite to an enable signal of the Band Gap circuitry.

According to another embodiment of the invention, a method is proposed for generating a controlled current by means of a Band Gap circuitry comprising:
supplying, on a Band Gap node, a voltage signal that is stable in temperature and power supply, indicated as a Band Gap voltage;
driving a controlled current generator by means of this Band Gap voltage signal;
locally suppressing a disturbance of a controlled current signal generated by the controlled current generator by means of a disturbance suppression circuit connected to the Band Gap node acting on this Band Gap voltage signal; and
mirroring the controlled current signal generated on an output terminal of the Band Gap circuitry.

In particular, locally suppressing the disturbance of the controlled current signal comprises emulating a behavior that is opposite to a behavior of a circuit or load connected to the Band Gap circuitry, in particular a sense amplifier. In substance, the method provides that emulating influences the controlled current generated by the Band Gap circuitry in the opposite direction with respect to the influence of the load connected thereto, canceling the disturbance effects of this load on the controlled current thus generated.

Advantageously according to an embodiment of the invention, emulating particularly provides for the use of a compensation capacitor connected to the Band Gap node and driven by an enable signal SAEN opposite to an enable signal SAEN_N of the Band Gap circuitry.

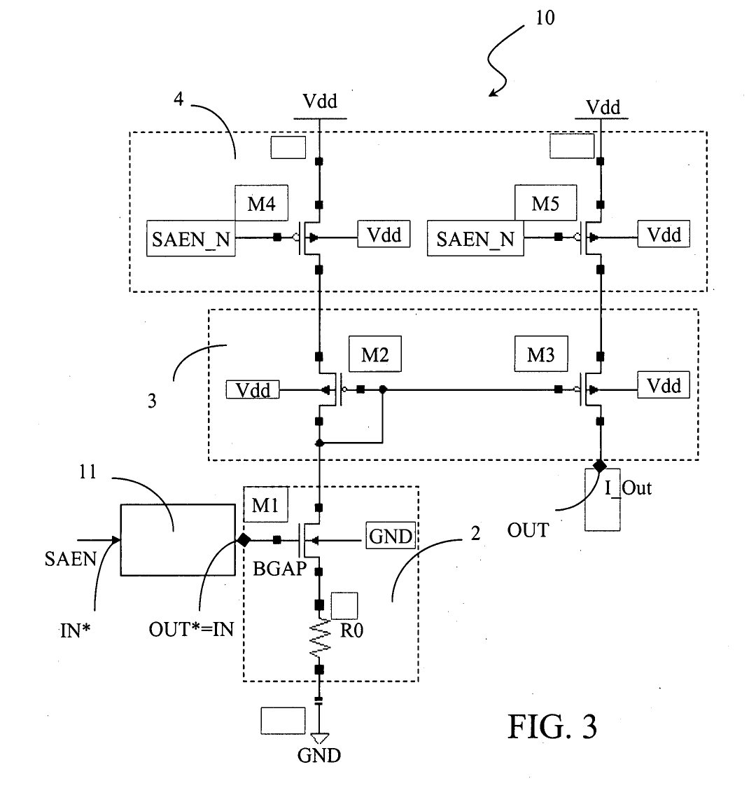

The method for generating a controlled current according to an embodiment of the invention is implemented by means of a Band Gap circuitry, is schematically shown in FIG. 3 and globally indicated with 10.

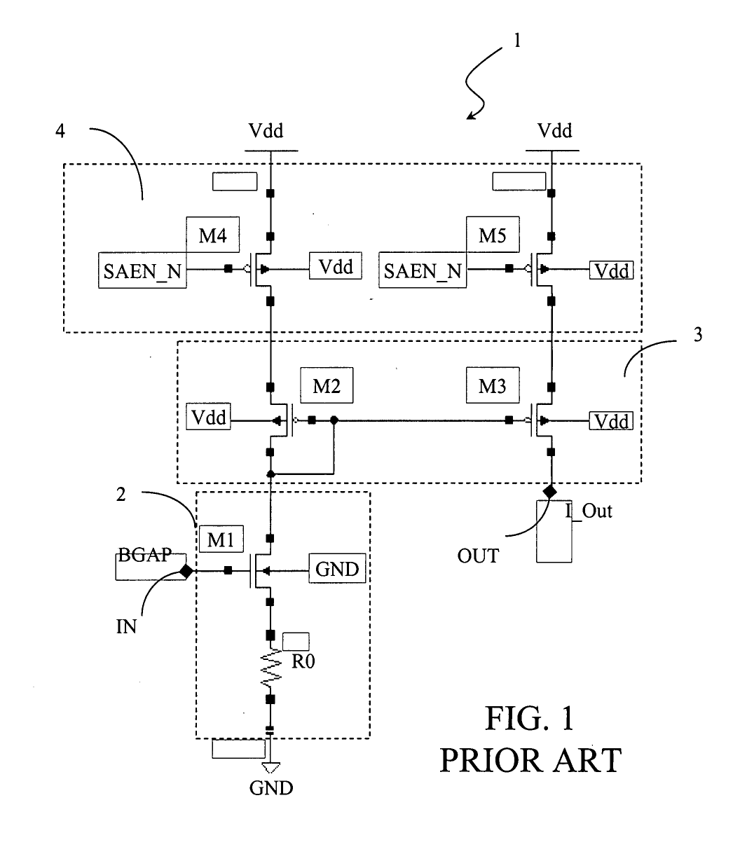

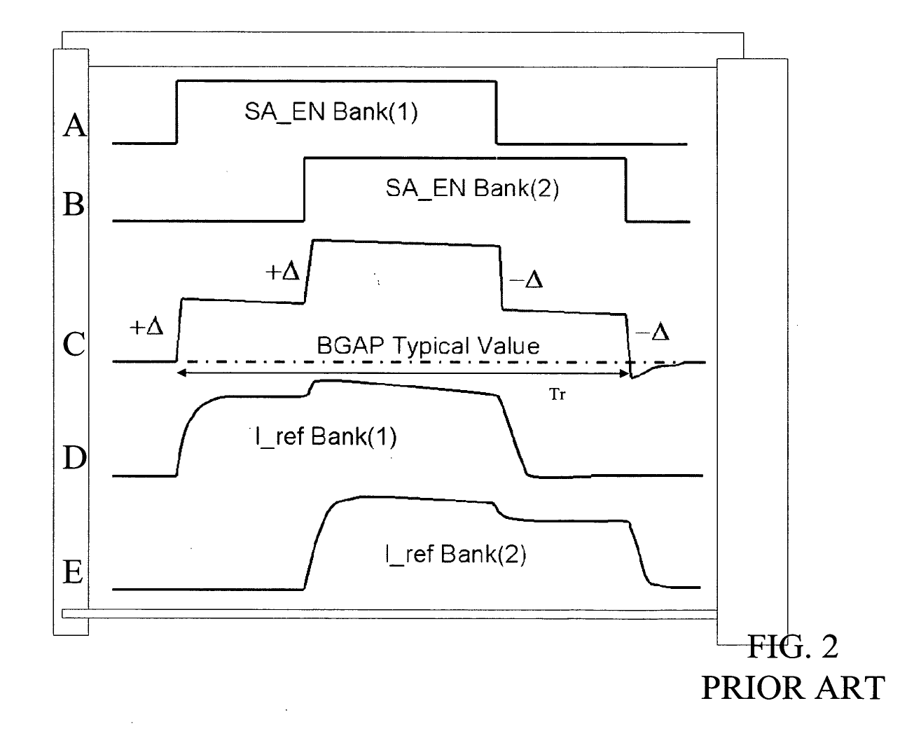

The Band Gap circuitry 10 according to an embodiment of the invention has a base structure corresponding to the Band Gap circuitry 1 described in connection with the prior art and shown in FIG. 1. Structurally and functionally identical elements will be given the same reference numbers by way of illustration.

The Band Gap circuitry 10 thus comprises, as previously seen, a controlled current generator 2, a current mirror 3 and an enable circuitry 4, cascade inserted between a first and a second voltage reference, in particular a supply voltage Vdd and a ground potential GND.

The current generator 2 comprises a LV transistor M1, in particular of the MOS type with N channel, having a control terminal or gate connected to an input terminal IN of the Band Gap circuitry 1, receiving the Band Gap voltage BGAP and corresponding to a Band Gap node BGAP, a first conduction terminal, in particular a source terminal, connected to the ground GND through a degeneration resistor R0 and a second conduction terminal, in particular a drain terminal, connected to the current mirror 3.

In turn, the current mirror 3 comprises a first mirror transistor M2, in particular of the MOS type with P channel, diode configured, inserted between the enable circuitry 4 and the generator 2 of a Band Gap voltage and having a control terminal or gate connected to a control terminal or gate of a second mirror transistor M3, inserted between the enable circuitry 4 and an output terminal OUT of the Band Gap circuitry 1, where an output controlled current signal I_OUT is generated.

Finally, the enable circuitry 4 comprises a first enable transistor M4 inserted between the supply reference Vdd and the first mirror transistor M2 of the current mirror 3 and having a control terminal or gate receiving an enable signal SAEN_N, as well as a second enable transistor M5 inserted between the supply reference Vdd and the second mirror transistor M3 of the current mirror 3 and having a control terminal or gate receiving the enable signal SAEN_N.

Advantageously according to an embodiment of the invention, the Band Gap circuitry 10 also comprises a disturbance suppression circuit 11, having an input terminal IN* receiving a further enable signal SAEN and an output terminal OUT* connected to the input terminal IN of the Band Gap circuitry 10. In particular, the disturbance suppression circuit 11 realizes the local suppression of disturbances, as it will be apparent hereafter in the description.

In the embodiment shown in FIG. 3, the LV transistor M1 of the controlled current generator 2 has a bulk terminal connected to the ground GND, while the mirror transistors M2 and M3 as well as the enable transistors M4 and M5 have bulk terminals connected to the supply voltage reference Vdd.

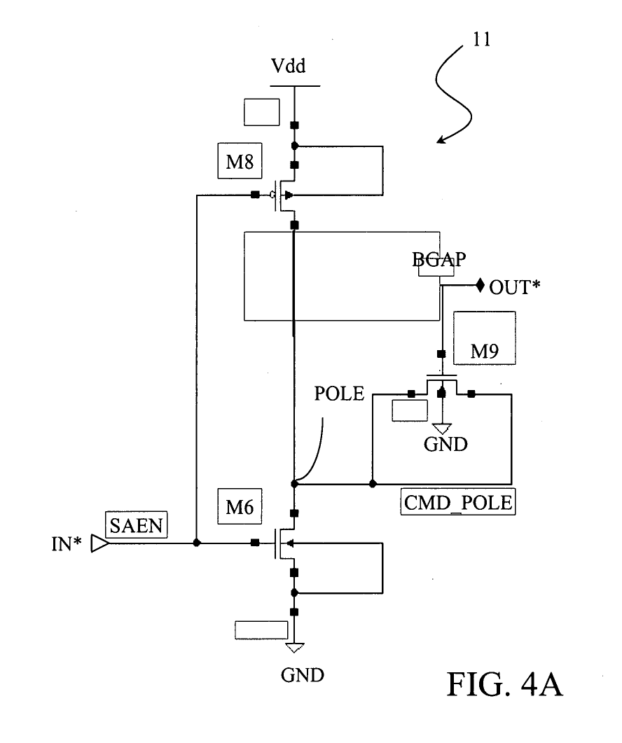

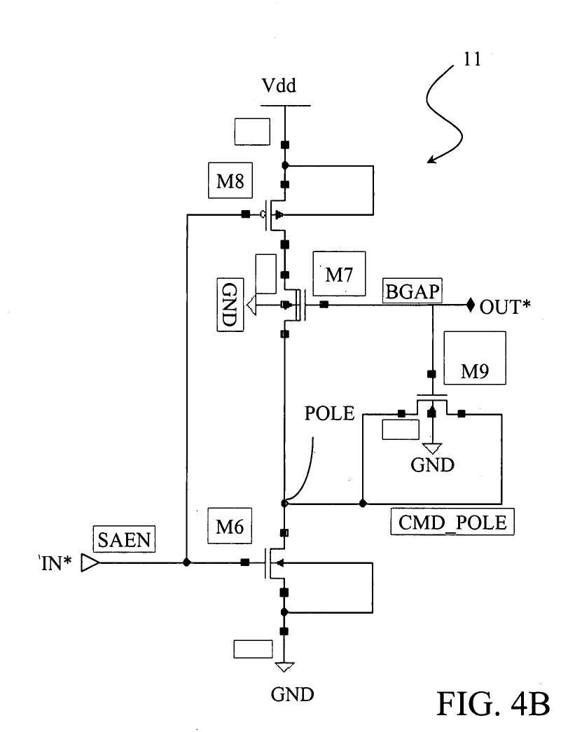

The disturbance suppression circuit 11 realized according to an embodiment of the invention is shown in greater detail in FIG. 4A.

In particular, the disturbance suppression circuit 11 comprises an input transistor M6, in particular a MOS transistor with N channel, having a control terminal or gate connected to the input terminal IN* of the disturbance suppression circuit 11, a first conduction terminal, in particular a drain terminal, connected to an inner circuit node POLE and a second conduction terminal, in particular a source terminal connected to the ground GND.

The inner circuit node POLE is connected, by means of a switching transistor M8, in particular a MOS transistor with P channel, to the supply voltage reference Vdd.

Advantageously according to an embodiment of the invention, the disturbance suppression circuit 11 also comprises a compensation capacitor inserted between the inner circuit node POLE and the output terminal OUT* of the disturbance suppression circuit 11. In the embodiment shown in FIG. 4A, this compensation capacitor is realized by means of a further coupling transistor M9, in particular a MOS transistor with N channel, having the conduction terminals connected to the inner circuit node POLE and a control terminal or gate connected to the output terminal OUT*, in turn connected to the input terminal IN of the Band Gap circuitry 10 and receiving the Band Gap voltage BGAP.

In a preferred embodiment of the disturbance suppression circuit 11 of the invention, shown in FIG. 4B, a threshold transistor M7 is also inserted between the switching transistor M8 and the inner circuit node POLE.

In particular, the threshold transistor M7 has a control terminal or gate connected to the output terminal OUT*, a first conduction terminal, in particular a drain terminal, connected to the switching transistor M8 and a second conduction terminal, in particular a source terminal, connected to the inner circuit node POLE.

Moreover, the switching transistor M8 has a control terminal or gate connected to the input terminal IN*, a first conduction terminal, in particular a source terminal, connected to the supply voltage reference Vdd and a second conduction terminal, in particular a drain terminal, connected to the threshold transistor M7.

In the embodiment shown in FIG. 4B, the threshold transistor M7 is a natural transistor in cascode configuration and it has a bulk terminal connected to the ground GND, while the switching transistor M8 has a bulk terminal connected to the supply voltage reference.

Finally, the coupling transistor M9 has a control terminal or gate connected to the output terminal OUT*, a first and a second conduction terminal connected to the inner circuit node POLE and a bulk terminal connected to the ground GND. The coupling transistor M9 thus serves as capacitor for compensating the variations introduced through capacitive coupling by the switching on and off of the circuits or loads connected to the Band Gap circuitry 10, in particular sense amplifiers.

It is worthwhile to note that on the inner circuit node POLE there is a control signal CMD_POLE, that the input terminal IN* receives the further enable signal SAEN, that is the inverted enable signal SAEN_N for the enable transistors M4 and M5 of the enable circuitry 4 and that the output terminal OUT* supplies a current signal BGAP compensated with the disturbances.

Let's now see the operation of the disturbance suppression circuit 11 of the invention, that substantially emulates a behavior opposite with respect to the rest of the Band Gap circuitry 10 in correspondence with the switching on of a load, in particular a sense amplifier to whom this Band Gap circuitry 10 is connected.

Advantageously according to an embodiment of the invention, the disturbance suppression circuit 11 provides that a capacitor (realized by the coupling transistor M9) is connected between the output terminal OUT*, where there is the Band Gap voltage signal BGAP, and the inner circuit node POLE, where the control signal CMD_POLE is applied so that the disturbance suppression signal 11 has a behavior opposed to the Band Gap circuitry 10 under on and off conditions of the same and thus of the load connected thereto, in particular a sense amplifier.

In particular, under off conditions of the sense amplifier, i.e. for high values of the enable signal SAEN_N of the enable circuitry 4, the further enable signal SAEN has a low value, in particular the ground value GND, and applies, the input transistor M6 being off, a positive voltage value to the inner circuit node POLE thanks to the switching on of the switching transistor M8. In its embodiment shown in FIG. 4A, this positive voltage value is given by the supply voltage Vdd, while in the embodiment shown in FIG. 4B, this positive voltage value is given by the Band Gap voltage BGAP decreased by a threshold voltage value Vth of the threshold transistor M7.

At the switching on of the sense amplifier, the enable signal SAEN_N is brought to a low value while the further enable signal SAEN is brought at a high value, in particular to the supply voltage value Vdd, switching on the input transistor M6 and forcing the inner circuit node POLE to a value corresponding to the ground GND. Under these conditions, the capacitor realized by the coupling transistor M9 decreases the potential value of the output terminal OUT*, i.e. of the Band Gap voltage signal BGAP, compensating the behavior of the rest of the Band Gap circuitry 10 which, as previously described in connection with the prior art, tends instead to enhance this Band Gap voltage signal BGAP.

Advantageously according to an embodiment of the invention, the value of the capacitor realized by the coupling transistor M9 and the variation of the potential of the control signal CMD_POLE are suitably calibrated for compensating at the best the behavior of the rest of the Band Gap circuitry 10 and in particular the injection of positive charge created by the switching on of the current mirror 3.

In particular, when the sense amplifier is off, the control signal CMD_POLE is brought to a value equal to the supply voltage Vdd. In this case, a little noisy supply voltage reference is to be provided, to avoid introducing, through capacitive coupling, this noise on the output terminal OUT*, i.e. on the Band Gap node.

As it has been seen in a preferred embodiment of the disturbance suppression circuit 11, if the disturbance suppression circuit 11 includes the threshold transistor M7, the control signal CMD_POLE is brought to a value equal to the Band Gap voltage BGAP decreased by a threshold voltage value of the threshold transistor M7.

In a further preferred embodiment, the threshold transistor M7 is a natural transistor, thus having a very little threshold voltage value, connected to the output terminal OUT* in a cascode configuration. In this way, the threshold transistor M7 allows to de-couple the supply voltage reference Vdd from the output terminal OUT*, i.e. from the Band Gap node.

It is also possible to use a threshold transistor M7 realized by a Low Voltage transistor, to further improve the de-coupling between the supply voltage reference Vdd and Band Gap node. In this case, the control signal CMD_POLE has however definitely low voltage values, which must be suitably managed.

Finally, the transistor M9 which realizes the coupling capacitor with the Band Gap node BGAP is a Low Voltage transistor having dimensions that can be compared with those of the LV transistor M1 of the controlled current generator 2, to obtain a better emulation of the opposite behavior of the Band Gap circuitry 10 under on and/or off switching conditions.

It is obvious that similar considerations are also valid in case of off switching conditions. In particular, the following conditions are valid:
if the sense amplifier is off (OFF), the input transistor M6 is off (OFF) and the switching transistor M8 is on (ON); while
if the sense amplifier is on (ON), the input transistor M6 is on (ON) and the switching transistor M8 is off (OFF).

In conclusion, the proposed method for generating a controlled current, the circuit for suppressing disturbances and the Band Gap circuitry allow to compensate for the disturbances introduced through capacitive coupling by the switching on/off of sense amplifiers on a sense amplifier already operating and attain several advantages among which is an incredible functional and structural simplicity of the circuits proposed, which allow for an easy regulation of their operation together with a containment of the costs and of the areas necessary for realizing them.

Moreover, advantageously according to an embodiment of the invention, the method for generating a regulated current has a beneficial effect also on the self-induced disturbances, i.e. on the operation disturbances of a sense amplifier linked to the switching on of the other sense amplifiers belonging to a same bank. In particular, the disturbance compensation obtained ensures the correct operation of all the sense amplifiers of a bank, independently from the switching on/off conditions of the other sense amplifiers of this bank.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A method for locally suppressing a disturbance of a reference line comprising:
supplying, on an internal node, a Band Gap voltage signal that is stable in temperature and power supply;
driving a controlled current generator generating a controlled current signal by means of the Band Gap voltage signal;
locally suppressing a disturbance of the reference line by means of a disturbance suppression circuit connected to the internal node acting on the Band Gap voltage signal; and
mirroring a current signal generated on the reference line which is an output terminal of the Band Gap circuitry.

2. The method of claim 1, wherein locally suppressing the disturbance of the controlled current signal comprises emulating a behavior that is opposite to a behavior of a load circuit connected to the Band Gap circuitry.

3. The method of claim 1, wherein emulating provides for the use of a compensation capacitor connected to the Band Gap node and driven by an enable signal opposite to an enable signal of the Band Gap circuitry.

4. A method for generating a controlled current by means of a Band Gap circuitry comprising:
supplying, on a Band Gap node, a Band Gap voltage signal that is stable in temperature and power supply;
driving a controlled current generator by means of the Band Gap voltage signal;
locally suppressing a disturbance of a controlled current signal generated by the controlled current generator by means of a disturbance suppression circuit connected to the Band Gap node acting on the Band Gap voltage signal; and
mirroring the controlled current signal generated on an output terminal of the Band Gap circuitry.

5. The method of claim 4, wherein locally suppressing the disturbance of the controlled current signal comprises emulating a behavior that is opposite to a behavior of a load circuit connected to the Band Gap circuitry.

6. The method of claim 4, wherein emulating provides for the use of a compensation capacitor connected to the Band Gap node and driven by an enable signal opposite to an enable signal of the Band Gap circuitry.

7. A circuit for suppressing disturbances of a reference line where a controlled current signal is generated by a Band Gap circuitry on a Band Gap node comprising at least one compensation capacitor inserted between the Band Gap node and an inner circuit node of the disturbance suppression circuit, in turn connected to a first voltage reference by means of an input transistor having a control terminal connected to an input terminal of the disturbance suppression circuit and receiving an enable signal.

8. The circuit for suppressing disturbances of claim 7, further comprising at least one switch inserted between a second voltage reference and the inner circuit node.

9. The circuit for suppressing disturbances of claim 8, further comprising at least one threshold transistor inserted between the switch and the inner circuit node and having a control terminal connected to the Band Gap node.

10. The circuit for suppressing disturbances of claim 7, wherein the compensation capacitor comprises a transistor having a control terminal connected to the Band Gap node and conduction terminal connected to the inner circuit node.

11. The circuit for suppressing disturbances of claim 10, wherein the transistor is a MOS transistor with N channel.

12. The circuit for suppressing disturbances of claim 11, wherein the transistor has a bulk terminal connected to the first voltage reference.

13. The circuit for suppressing disturbances of claim 11, wherein the transistor is a Low Voltage transistor.

14. The circuit for suppressing disturbances of claim 7, wherein the input transistor has a first conduction terminal connected to the inner circuit node and a second conduction terminal connected to the first voltage reference.

15. The circuit for suppressing disturbances of claim 14, wherein the input transistor is a MOS transistor with N channel.

16. The circuit for suppressing disturbances of claim 15, wherein the input transistor has a bulk terminal connected to the first voltage reference.

17. The circuit for suppressing disturbances of claim 8, wherein the switch is a transistor having a control terminal connected to the input terminal, a first conduction terminal connected to the second voltage reference and a second conduction terminal connected to the inner circuit node.

18. The circuit for suppressing disturbances of claim 14, wherein the transistor is a MOS transistor with P channel.

19. The circuit for suppressing disturbances of claim 18, wherein the transistor has a bulk terminal connected to said second voltage reference.

20. The circuit for suppressing disturbances of claim 9, wherein the threshold transistor is a natural transistor in cascode configuration.

21. The circuit for suppressing disturbances of claim 20, wherein the threshold transistor has a bulk terminal connected to the first voltage reference.

22. The circuit for suppressing disturbances of claim 9, wherein the threshold transistor is a Low Voltage transistor.

23. A Band Gap circuitry, inserted between a first and a second voltage reference, comprising:
a controlled current generator, being connected to an input terminal receiving a Band Gap voltage signal that is stable in temperature and power supply;
a current mirror, being connected to an output terminal suitable for supplying a controlled current signal;
an enable circuitry, receiving an enable signal; and
a circuit for suppressing disturbances connected to the input terminal of the Band Gap circuitry.

24. The Band Gap circuitry of claim 23, wherein the circuit for suppressing disturbances comprises at least one compensation capacitor inserted between a Band Gap node and an inner circuit node, in turn connected to a first voltage reference by means of an input transistor having a control terminal connected to an input terminal of the disturbance suppression circuit and receiving an enable signal.

25. The Band Gap circuitry of claim 24, wherein the circuit for suppressing disturbances further comprises at least one switch inserted between a second voltage reference and the inner circuit node.

26. The Band Gap circuitry of claim 25, wherein the circuit for suppressing disturbances further comprises at least one threshold transistor inserted between the switch and the inner circuit node and having a control terminal connected to the Band Gap node.

27. The Band Gap circuitry of claim 26, wherein the compensation capacitor comprises a transistor having a control terminal connected to the Band Gap node and conduction terminal connected to the inner circuit node of the circuit for suppressing disturbances.

28. The Band Gap circuitry of claim 23, wherein the enable signal of the enable circuitry is the inverted signal of the enable signal of the disturbance suppression circuit.

29. The Band Gap circuitry of claim 20, wherein the transistor which realizes the coupling capacitor is a Low Voltage transistor having dimensions that may be compared with those of a transistor comprised in the controlled current generator.
